(19) United States
(12) Patent Application Publication
(10) Pub. No.: US 2005/0190932 A1
(43) Pub. Date: Sep. 1, 2005

(54) Streophonic apparatus having multiple switching function and an apparatus for controlling sound signal

(76) Inventors: Min-Hwan Woo, Daegu (KR); Duk-Gyoo Kim, Daegu (KR); Il-Sun Kang, Daegu (KR); Il-Hyung Lee, Seoul (KR); Sung-Heum Baek, Incheon (KR); Sang-Kyu Kang, Seoul (KR)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/659,750

(22) Filed: Sep. 11, 2003

(30) Foreign Application Priority Data
Sep. 12, 2002 (KR) 10-2002-0055213

(51) Int. Cl. H04R 5/00; H04Q 7/20; H04M 11/00

(52) U.S. Cl. 381/119; 381/1; 381/123; 455/403

(57) ABSTRACT

The present invention, related to a stereophonic apparatus having multiple switching function which mixes the sound signals output from multiple sound apparatuses to output them at once and enables to output multiply or selectively, has an audio signal generating unit for generating an audio signal, a sound signal controlling unit for outputting a sound signal to a sound signal input terminal of an external sound apparatus and controlling path of a sound signal output from a sound signal output terminal of said external sound apparatus, a mixing unit for generating a mixed sound signal by mixing an audio signal input from said audio signal generating unit and a sound signal input through said sound signal controlling unit, an audio amplifying unit for amplifying a mixed sound signal input from said mixing unit, and an output unit for outputting a mixed sound signal amplified by said audio amplifying unit.

### FIELD OF THE INVENTION

The present invention relates to a stereophonic apparatus having multiple switching function and an apparatus for controlling sound signal, and more particularly, to a stereophonic apparatus having multiple switching function and an apparatus for controlling sound signal which mixes the sound signals output from a plural of sound apparatuses to output them at once and enables to output them multiply or selectively.

### PRIOR ART

Recently, as the restriction on using a mobile phone in a car gets tougher, the use of hands-free phone is increasing rapidly. There are a typical hands-free phone attached on one side of the inside of the car and a built-in hands-free phone mounted internally. The built-in hands-free phone is generally used by mounting the single unit, with an exclusion of a speaker from the constitutional units of conventional external hands-free phone, in the inner unit of the car during the production process of the car and connecting the speaker to the speaker of car audio.

FIG. 1 is a schematic block diagram of the hands-free phone apparatus using the conventional audio apparatus for cars.

As shown in FIG. 1, a conventional built-in hands-free phone apparatus is implemented by adding a microphone 108 and a phone interface 114 to an audio apparatus 104, equipped with an audio amplifier 122 and a speaker 110. An adapter cable connects interface connector (not shown) with the phone interface 114, equipped in a mobile phone 100, to connect with the conventional hands-free phone kit.

Referring to FIG. 1, an audio switch 116 is switched by a switching controlling unit 124 and applies the audio signal which is output from one of the audio transmission terminal of the media playing unit 118, a radio receiving unit 120, and the phone interface 114 to the audio amplifier 122. The audio amplifier 122 amplifies the audio signal transmitted via the audio switch 116 and the audio signal is output through the speaker 110.

The switching controlling unit 124 switches a power switch 128 and the audio switch 116 corresponding to the units getting used among the media playing unit 118, radio receiving unit, audio amplifier 122, and the mobile phone 100. That is, when the media playing unit 118 is being used, it applies the power of the power unit 126 to the media playing unit 118 and the audio amplifier 122 and, at the same time, applies the audio signal output from the media playing unit 118 to the audio amplifier 122. According to this, the audio signal is output through the speaker 110. When the radio receiving unit 120 is being used, it applies the power to the radio receiving unit 120 and the audio amplifier 122 and at the same time, applies the audio signal output from the radio receiving unit 120 to the audio amplifier 122. According to this, the audio signal which is received by the radio receiving unit 120 is output through the speaker 110. And when the mobile phone 100 is being used, it applies the power to a phone interface 140 and the audio amplifier 122 and, at the same time, applies the signal output from the mobile phone 100. The audio signal transmitted from mobile phone 100 is output through the speaker 110.

However, the conventional built-in hands-free phone apparatus outputs only one of the sound signals output from the radio or media playing unit and the voice signal selectively. Accordingly it causes a problem of not being able to listen to music or news while the signal of the mobile phone is being output. Also, there is a demerit of high production cost since it requires the additional composition of the audio switch and switch controlling unit.

Therefore, the demands of a sound signal control apparatus, which overcomes the unreasonable aspect of the conventional built-in hands-free phone and enables the multiple or selective reception of the audio signals of the media playing unit or radio receiving unit and the signal of the mobile phone, is rising.

### SUMMARY OF THE INVENTION

The present invention solves the problems mentioned above, and provides a stereophonic apparatus having multiple switching function and an apparatus for controlling sound signal, which can let only a high level sound signal to be heard, by a mute phenomenon, that relatively a weak signal can hardly be heard, resulting from mixing the sound signals output from multiple sound apparatuses and letting them to be output at once.

And also, the present invention provides a stereophonic apparatus having multiple switching function and an apparatus for controlling sound signal which can output the sound signals output from multiple sound apparatuses multiply or selectively.

The present invention to achieve the goals mentioned above, is a stereophonic apparatus having multiple switching function, which an audio signal generating unit for generating an audio signal, a sound signal controlling unit for outputting a sound signal to a sound signal input terminal of an external sound apparatus and controlling path of a sound signal output from a sound signal output terminal of said external sound apparatus, a mixing unit for generating a mixed sound signal by mixing an audio signal input from said audio signal generating unit and a sound signal input through said sound signal controlling unit, an audio amplifying unit for amplifying a mixed sound signal input from said mixing unit, and an output unit for outputting a mixed sound signal amplified by said audio amplifying unit.

According to the present invention, a stereophonic apparatus having multiple switching function, which can let only a high level sound signal to be heard, by a mute phenomenon, that relatively a weak signal can hardly be heard, resulting from mixing the sound signals output from multiple sound apparatuses and letting them to be output at once, is provided. Also, according to the present invention, a stereophonic apparatus having multiple switching function enabling to output the sound signals output from multiple sound apparatuses multiply or selectively is provided.

According to the present invention to achieve the goals mentioned above, a sound signal control apparatus, coupled to a stereophonic apparatus and a mobile phone, which comprises a microphone unit, having one end connected to a sound signal input terminal of said mobile phone and other end grounded, which converts a voice signal into a sound signal and transmits it to said sound signal input terminal of said mobile phone, a calling mode conversion switch, having one end connected to said sound signal input terminal of said mobile phone and the other end grounded, which switches an operating condition of said mobile phone to a calling mode or a call waiting mode, and a secret call switch for switching a sound signal input from said sound signal output terminal of the mobile phone to a mixing unit of said stereophonic apparatus or a secret call output unit can be provided.

According to the present invention, a sound signal control apparatus, which can let only a high leveled sound signal to be heard, by a mute phenomenon, that relatively a weak signal can hardly be heard, resulting from mixing the sound signals output from multiple sound apparatuses and letting them to be output at once, is provided. Also, according to the present invention, a sound signal control apparatus enables to output the sound signals output from multiple sound apparatuses multiply or selectively is provided.

### BRIEF DESCRIPTION OF THE DRAWINGS

FIG. 1 is a schematic block diagram of the hands-free phone apparatus using conventional audio apparatus for cars.

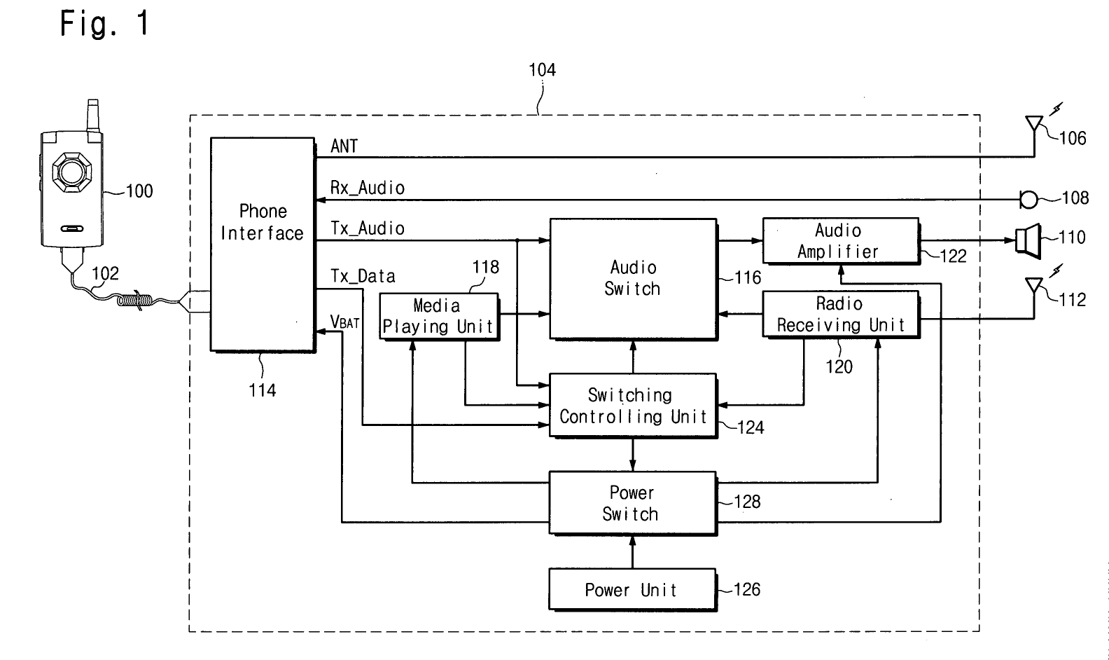

FIG. 2 is a block diagram of the stereophonic apparatus having multiple switching function according to the present invention.

FIG. 3 is a block diagram of the sound signal controlling unit according to the first embodiment of the present invention.

FIG. 4 is a block diagram of the sound signal controlling unit according to the second embodiment of the present invention.

FIG. 5 is a block diagram of the sound signal controlling unit according to the third embodiment of the present invention.

FIG. 6 is a circuit diagram of the sound signal controlling unit of FIG. 5.

### DETAILED DESCRIPTION OF THE PREFERRED EMBODIMENTS

Hereinafter, referring to the following appended drawings, the preferred embodiments of the present invention will be explained in detail.

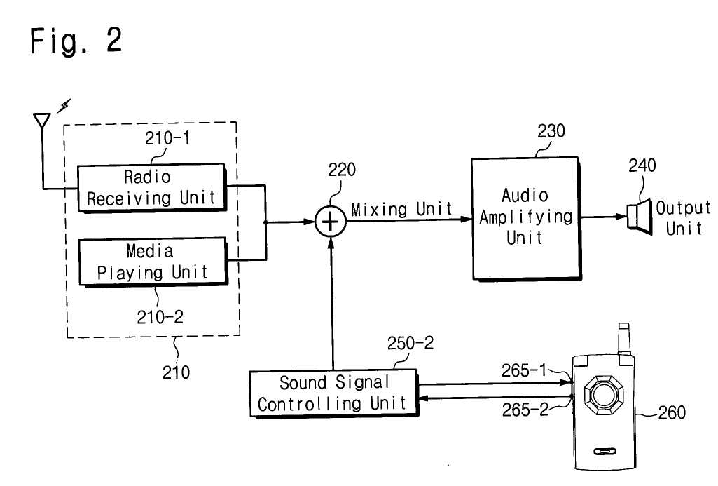

FIG. 2 is a block diagram of the stereophonic apparatus having multiple switching function according to the present invention.

As shown in FIG. 2, the stereophonic apparatus having multiple switching function comprises an audio signal generating unit 210, a mixing unit 220, an audio amplifying unit 230, an output unit 240, a sound signal controlling unit 250-2, and include external sound apparatus having a sound signal input terminal 265-1 and a sound signal output terminal 265-2.

The audio signal generating unit 210 includes a radio receiving unit 210-1, which converts radio signals received via antenna to audio signal and the media playing unit 210-2, which generates audio signal by playing media in which sound is recorded sound, such as CD, tape, and DVD.

The mixing unit 220 mixes the audio sound input from the audio signal generating unit 210 and the sound signal input from the sound signal controlling unit 250-2, and inputs the mixed signal to the audio amplifying unit 230.

The audio amplifying unit 230 amplifies the mixed signal input from the mixing unit 220 and outputs it through the output unit 240, generally corresponding to speaker.

The sound signal controlling unit 250-2 outputs the sound signal converted by a microphone (explained below) to the sound signal input terminal 265-1 of the mobile phone 260, and controls the path of the sound signal output from the sound signal output terminal 265-2 of a mobile phone 260. Wherein, the path of the sound signal is the mixing unit 220 or the secret call output unit (explained below).

In the following, the operation of the stereophonic apparatus having multiple switching function will be explained according to the present invention in detail referring to FIG. 2.

If a user of the mobile phone 260 changes the mode of the mobile phone 260 to a calling mode by switching the calling mode converting switch to answer a phone, the mixing unit 220 mixes the audio signal input from the audio signal generating unit 210 and the sound signal output from the sound signal output terminal 265-2 after being amplified in the mobile phone 260. The mixed sound signal in the mixing unit 220 is input to the audio amplifying unit 230. The DC components of the audio signal and the sound signal are almost the same but the AC component of the audio signal has 5 to 10 times lower signal power than the AC component of the sound signal.

And the mixed sound signal, which is mixed in the mixing unit 220 and then is input to the audio amplifying unit 230, is amplified in the amplifying unit 230 adjusted to an amplification factor fitted to the power level of the mixed sound signal. Therefore, since the audio signal having low level, output from the audio signal generating unit 210, still has low level even though it is amplified by the audio amplifying unit 230, it can hardly been heard by the user as a mute phenomenon occurred. Also, when the sound signal having high level output from the sound signal output terminal 265-2 of the mobile phone 260 is output through the output unit 240, it can be heard by the user as an normal audio is heard, since the level gets higher if it gets amplified by the audio amplifying unit 230.

The reason for these phenomena is because the magnitude of the output power is generally controlled by the volume controlling unit and the amplification controlling unit. That is, the amplification controlling unit obtains the power level of the signal input to the audio amplifying unit 230 and when the power level of the signal differs from the predetermined level by the volume controlling unit, it controls the amplification factor of the audio amplifying unit 230.

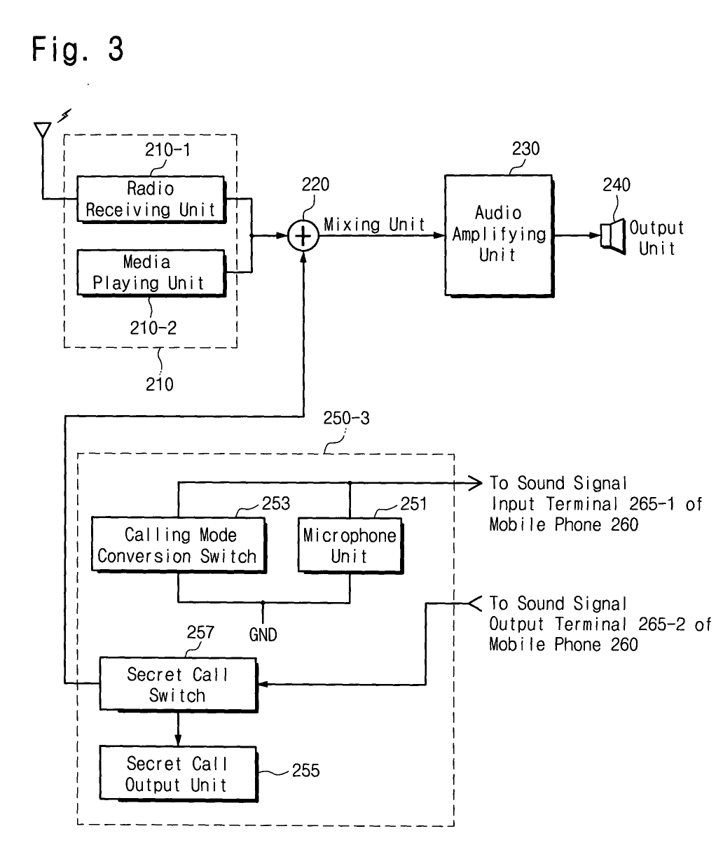

FIG. 3 is a block diagram of the sound signal controlling unit according to the first embodiment of the present invention.

As shown in FIG. 3, the sound signal controlling unit 250-3 comprises a microphone unit 251, a calling mode conversion switch 253, a secret call switch 257, and a secret call output unit 255.

The microphone unit 251 has one end connected to the sound signal input terminal 265-1 of the mobile phone 260 and the other end connected to the GND. The microphone unit 251 converts the user's voice signal to sound signal and outputs this sound signal to the sound signal input terminal 265-1 of the mobile phone 260.

The calling mode conversion switch 253 has one end connected to the sound signal input terminal 265-1 of the mobile phone 260 and the other end to connected to the GND. The calling mode conversion switch 253 switches the operating condition of the mobile phone 260 to a calling mode or a call waiting mode, according to the user's switching. At this time, based on the signal according to the switching of the calling mode conversion switch 253, the microprocessor (not shown) of the mobile phone 260 switches the operating condition of the mobile phone 260 to a calling mode or a call waiting mode. Also, the calling mode conversion switch 253 can switch the operating condition of the mobile phone 260 from a call waiting mode to a recalling mode by the user of the mobile phone 260, by switching the calling mode conversion switch 253, when the operating condition of the mobile phone 260 is in a call waiting mode, and inputting the switching signal continuously in a number which is set previously in the microprocessor in the mobile phone 260, in a predetermined time set previously in the microprocessor in the mobile phone 260. At this point, the calling mode conversion switch 253 is a tact switch, which an instant contact occurs only at the moment of switching and then is released automatically.

The secret call switch 257 is connected to the sound signal output terminal 265-2 of the mobile phone 260 and switches the sound signal output from the sound signal output terminal 265-2 of the mobile phone 260 to the mixing unit 220 or to the secret call output unit 255. That is, when the user of the mobile phone 260 selects a secret call by switching of the secret call switch 257, other people cannot hear the sound signal since the user of the mobile phone 260 hears the sound signal output from the sound signal output terminal 265-2 through the secret call output unit 255 with an earphone or a headphone and so on. And when the user of the mobile phone 260 does not selects a secret call by switching of the secret call switch 257, other people can hear the sound signal since the user of the mobile phone 260 hears the sound signal output from the sound signal output terminal 265-2 through the output unit 240 corresponding to a speaker.

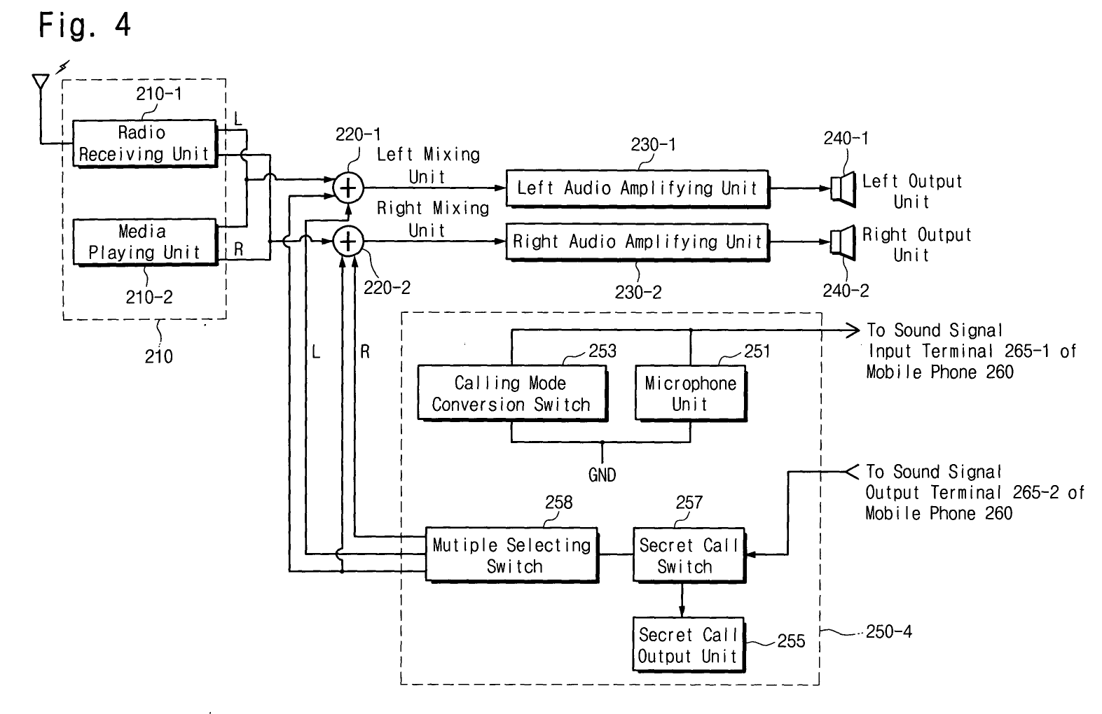

FIG. 4 is a block diagram of the sound signal controlling unit according to the second embodiment of the present invention.

As shown in FIG. 4, the sound signal controlling unit 250-4 according to the second embodiment has additionally the multiple selecting switch 258 in comparison with the sound signal controlling unit 250-3 of the first embodiment. Therefore, explanations of the same units with the first embodiment will be shortened and only about the multiple selecting switch 258, the left mixing unit 220-1 and right mixing unit 220-2 will be explained.

The multiple selecting switch 258 has one end connected to the secret call switch and the other ends are connected to the left mixing unit 220-1 and right mixing unit 220-2. The multiple selecting switch 258 switches the sound signal input from the sound signal output terminal 265-2 of the mobile phone 260 to at least one of the left mixing unit 220-1 and right mixing unit 220-2. That is, the sound signal can be input to either the left mixing unit 220-1 or the right mixing unit 220-2, or to both the left mixing unit 220-1 and the right mixing unit 220-2, according to the switching of the multiple selecting switch 258.

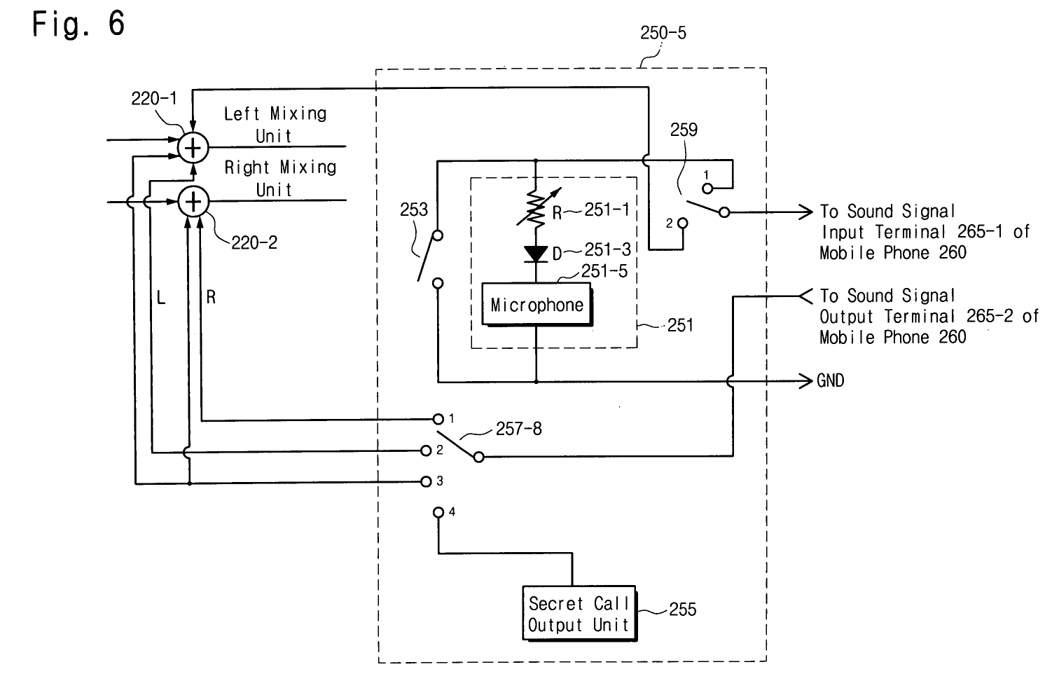

At this point, the multiple selecting switch 258 and the secret call switch 257 can be integrated into one switch by a simple change of design which is obvious to those skilled in the art, as the secret call and multiple selecting switch 257-8 as shown in FIG. 6 mentioned later. The sound signal output from the sound output terminal 265-2 of the mobile phone 260 is output to the secrete call output unit 255 to use it as a secrete call switch when the switch is switched to a secrete call. The sound signal output from the sound signal output terminal of the mobile phone 260 is switched to at least one of the left mixing unit 220-1 and the right mixing unit 220-2 when the switch is not switched to a secrete call to use it as a multiple selecting switch. Accordingly the switch can be used as a secrete switch and a multiple selecting switch.

According to the second embodiment, the sound signal output from the sound signal output terminal 265-2 of the mobile phone 260 can be switched to at least one of the left mixing unit 220-1 and the right mixing unit 220-2.

Therefore the sound signal input from the sound signal output terminal 265-2 is output through the L output unit 240-1/R output unit 240-2 after it is amplified by the L audio amplifying unit 230-1/R audio amplifying unit 230-2 when the multiple selecting switch 258 is switched to the L mixing unit 220-1/R mixing unit 220-2, and the R audio signal/L audio signal output from audio signal generating unit 210 is output to the R output unit 240-2/L output unit 240-1 after it is amplified by the R audio amplifying unit 230-2/L audio amplifying unit 230-1. Accordingly, the user can hear the sound signal through the L output unit 240-1/R output unit 240-2 and the audio signal through the R output unit 240-2/L output unit 240-1. If the multiple selecting switch is switched to both the L mixing unit 220-1 and the R mixing unit 220-2, the sound signal input from the sound signal output terminal 265-2 is output through both the L output unit 240-1 and the R output unit 240-2 after it is amplified by the L audio amplifying unit 230-1 and the R audio amplifying unit 230-2. And the audio signal input from the audio signal generating unit 210 is muted, so that the user can hardly hear the audio signal.

As mentioned in the explanation referring to FIG. 2, this is because of the mute phenomenon that the audio signal of low level is hardly heard, since the mixed sound signal of an audio signal of low level and a sound signal of high level is amplified by the audio amplifier 230, which is adjusted to the amplification factor according to the power level of the signal.

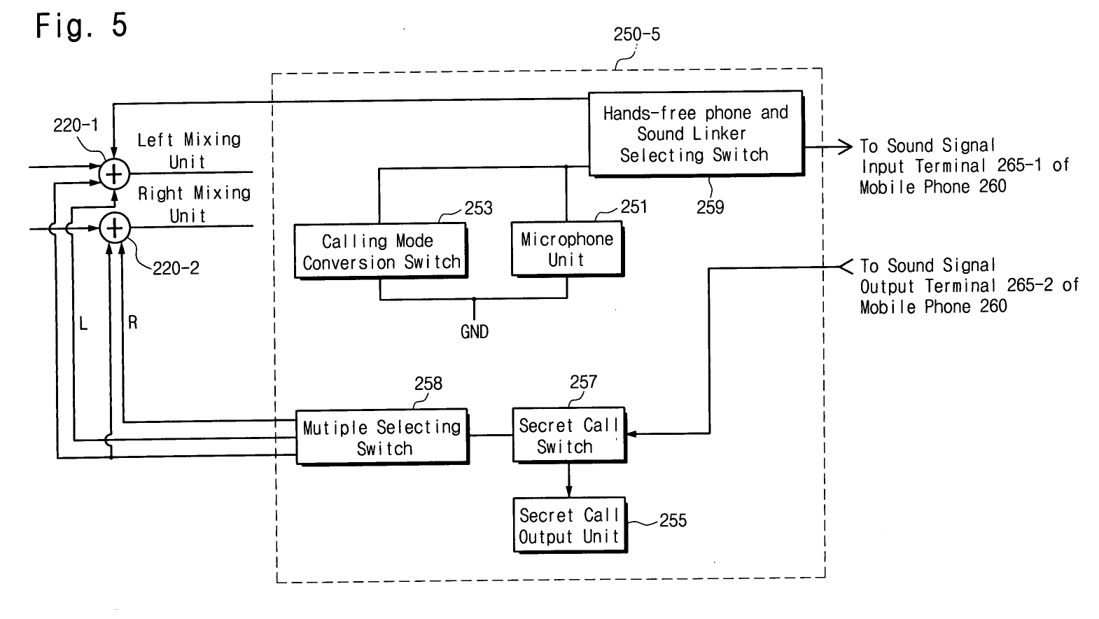

FIG. 5 is a block diagram of the sound signal controlling unit according to the third embodiment of the present invention.

As shown in FIG. 5, the sound signal controlling unit 250-5 according to the third embodiment has additionally the hands-free phone and sound linker selecting switch 259 in comparison with the sound signal controlling unit 250-4 according to the second embodiment. Therefore, explanation about the same units with the first and second embodiment will be shortened and only about the hands-free phone and sound linker selecting switch 259 will be explained.

The hands-free phone and sound linker selecting switch 259 has one end connected to the sound signal input terminal 265-1 of the mobile phone 260 and allows to be connected selectively to the opposite node of the GND node, which connects the microphone unit 251 and the calling mode conversion switch 253 in parallel, or to the left mixing unit 220-1. The change of the left mixing unit 220-1 to the right mixing unit 220-2 is an obvious change of design to those skilled in this art since the roles of the left mixing unit 220-1 and the right mixing unit 220-2 can be changed. Therefore, in the present embodiment, it is assumed that the hands-free phone and sound linker selecting switch 259 is switched so that it may be connected to the left mixing unit 220-1.

When the hands-free phone and sound linker selecting switch 259 is connected to the opposite node of the GND node, which connects the microphone unit 251 and the calling mode conversion switch 253 in parallel, it is same as what is explained in the third embodiment of the FIG. 4.

And when the hands-free phone and sound linker selecting switch 259 is connected to the left mixing unit 220-1, the external sound apparatus is generally not assumed as the mobile phone but as the use of MP3 and DVD as external audio apparatuses. That is, it is to use the terminal, which was used as a sound signal input terminal of the mobile phone, as the left terminal of the sound signal output terminal of the external audio apparatus, since the sound signal input terminal of the external audio apparatus is divided into left and right terminal while the mobile phone has sound signal input terminal and sound signal output terminal. If we explain the overall operation assuming that the external audio apparatus is a MP3, the sound signal output from the right sound signal output terminal go through the same process as the sound signal output from the sound signal output terminal of the mobile phone in the third embodiment of the FIG. 4, and is mixed with the audio signal input from the audio signal generating unit in the left mixing unit 220-1 or/and right mixing unit 220-2 in accordance with the switching of the multiple selecting switch. And the sound signal output from the left sound signal output terminal of the MP3 is input to the left mixing unit 220-1 and mixed with the audio signal input from the audio signal generating unit.

Therefore, the hands-free phone and sound linker selecting switch 259 can be applied to both the mobile phone and the external audio apparatus in multiple uses.

The multiple selecting switch 258 and the secret call switch 257 can be integrated into one switch by a simple change of design which is obvious to those skilled in the art, as the secret call and multiple selecting switch 257-8 as shown in FIG. 6 mentioned later.

The sound signal output from the sound output terminal 265-2 of the mobile phone 260 is output to the secrete call output unit 255 to use it as a secrete call switch when the switch is switched to a secrete call. The sound signal output from the sound signal output terminal of the mobile phone 260 is switched to at least one of the left mixing unit 220-1 and the right mixing unit 220-2 when the switch is not switched to a secrete call to use it as a multiple selecting switch. That is, when the switch is switched to a secrete call, the sound signal output from the sound signal output terminal 265-2 of the mobile phone 260 is output the secrete call output unit 255, and when the switch is not switched to a secrete call, the sound signal output from the sound signal output terminal 265-2 of the mobile phone 260 is switched to at least one of the left mixing unit 220-1 and the right mixing unit 220-2. Accordingly the switch can be used as a secrete switch and a multiple selecting switch.

FIG. 6 is a circuit diagram of the sound signal controlling unit of FIG. 5.

As shown in FIG. 6, the calling mode conversion switch 253 is connected to the microphone unit 251 are connected in parallel. One end of the calling mode conversion switch 253 is connected to the GND node and the other end of the calling mode conversion switch 253 is connected to the opposite node of the GND node.

The microphone unit 251 comprises variable resistor 251-1 of which an end is connected to the sound signal input terminal 265-1 of the mobile phone 260, diode 251-3 of which an end is connected to the other end of the variable resistor 251-1, and microphone 251-5 of which and end is connected to the other end of the diode 251-3 and the other end is connected GND node. The microphone 251-5 converts a voice signal to a sound signal and input it to the sound signal input terminal 265-1 of the mobile phone 260. It is obvious to those skilled in the art that the positions of the variable resistance and the diode can be interchanged without changing the direction of the diode.

The variable resistor 251-1 is used for controlling the output of microphone. It carries out a function for controlling the output of the microphone. When resistance of the variable resistor 251-1 is large, the communication party of the user of the mobile phone 260 hears the sound signal of low level since the sound output from the microphone 251-5 is reduced, when the resistance of the variable resistor 251-1 is small, the communication party of the user of the mobile phone 260 hears the sound signal of high level. However, when the value of resistance is small, echo and howling occurs. And so, resistance R should be in adequate value.

The diode 251-3 prevents the occurring of howling and echo during sending and receiving the sound signal from the sound signal output terminal of the mobile phone and the voice signal of the user from the microphone 270 in two directions, and when the diode 251-3 is constructed to the opposite direction, the transmitting sound is shut off and the communication party of the user cannot receive the transmitting sound signal of the user.

The multiple selecting switch and the secret call switch can be integrated into one switch by a simple change of design which is obvious to those skilled in the art, as the secret call and multiple selecting switch 257-8 as shown in FIG. 6.

The sound signal output from the sound output terminal 265-2 of the mobile phone 260 is output to the secrete call output unit 255 to use it as a secrete call switch when the secret call and multiple selecting switch 257-8 is switched to a secrete call. The sound signal output from the sound signal output terminal of the mobile phone 260 is switched to at least one of the left mixing unit 220-1 and the right mixing unit 220-2 when the secret call and multiple selecting switch 257-8 is not switched to a secrete call to use it as a multiple selecting switch. That is, when the secret call and multiple selecting switch 257-8 is switched to a secrete call, the sound signal output from the sound signal output terminal 265-2 of the mobile phone 260 is output the secrete call output unit 255, and when the secret call and multiple selecting switch 257-8 is not switched to a secrete call, the sound signal output from the sound signal output terminal 265-2 of the mobile phone 260 is switched to at least one of the left mixing unit 220-1 and the right mixing unit 220-2. Accordingly the secret call and multiple selecting switch 257-8 can be used as a secrete switch and a multiple selecting switch.

Hereinafter, a more detailed circuital explanation about the operation of the sound signal controlling unit 250-5, will be given in further detail referring to FIG. 6. In the following drawing, the units without the sign can be known easily by referring to FIG. 4.

First of all, the case of switching the hands-free phone and sound linker selecting switch 259 to position 1, which is the opposite node of the GND node which connects the microphone unit 251 and the calling mode conversion switch 253 in parallel, will be explained. This assumes the use of a mobile phone as an external sound apparatus.

The microphone unit 251 is connected to the sound signal input terminal 265-1 of the mobile phone 260. When the user's voice signal is input to the microphone unit 251, the user's voice signal is converted to the sound signal in the microphone unit 251 and is input to the sound signal input terminal 265-1 of the mobile phone 260.

When the secret call and multiple selecting switch 257-8 is switched to the position 1/position 2, the left(L) sound signal/right(R) sound signal, input from the sound signal input terminal 265-1 of the mobile phone 260, is mixed with the L audio signal/R audio signal, input from the audio signal generating unit 210, at the L mixing unit/R mixing unit, and is amplified by the L audio amplifying unit/R audio amplifying unit, and then is output through the L output unit/R output unit. Therefore, since the L audio signal/R audio signal has relatively lower power level than the L sound signal/R sound signal, the mute phenomenon that the amplified signal by the L audio amplifying unit/R audio amplifying unit, which then is output through the L output unit/R output unit, is hardly being heard from the user, occurs. And also, the L audio signal/R audio signal can be heard from the user as a general listening of an audio, when it is amplified by the L audio amplifying unit/R audio amplifying unit and output through the L output unit/R output unit. As a result, an audio signal can be heard from one output unit and a sound signal from the other output unit.

When the secret call and multiple selecting switch 257-8 is switched to the position 3, the L sound signal/R sound signal, input from the sound signal input terminal 265-1 of the mobile phone 260, is mixed with the L audio signal/R audio signal, input from the audio signal generating unit 210, at the L mixing unit/R mixing unit, and is amplified through the L audio amplifying unit/R audio amplifying unit, and then is output through the L output unit/R output unit. Therefore, since the L audio signal/R audio signal has relatively lower signal level than the L sound signal/R sound signal, the mute phenomenon that the amplified signal by the L audio amplifying unit/R audio amplifying unit, which then is output through the L output unit/R output unit, is hardly being heard from the user, occurs and only the L sound signal/R sound signal is heard.

When the secret call and multiple selecting switch 257-8 switches to position 4, the sound signal, input from the sound signal input terminal 265-1 of the mobile phone 260, is output through the secret call output unit 255, so it can be heard with an earphone or a headphone.

The calling mode conversion switch 253 has one end connected to the sound signal input terminal 265-1 of the mobile phone 260 and the other end connected to GND. If a contact is made at the moment of switching the calling mode conversion switch 253, a closed loop connecting the mobile phone 260 and the calling mode conversion switch 253 is formed and the current flows into the mobile phone 260. The microprocessor (not shown) in the mobile phone 260 detects the current as a control signal and switches an operating condition of the mobile phone 260. That is, when the calling mode conversion switch 253 is switched in a call waiting mode it is switched to a calling mode, and when the calling mode conversion switch 253 is switched in a calling mode it is switched to a call waiting mode. Also, the calling mode conversion switch 253 switches the mobile phone 260 from call waiting mode to recalling mode, by switching the calling mode conversion switch 253, when the operating condition of the mobile phone 260 is in a call waiting mode, and inputting the switching signal continuously in a number which is set previously in the microprocessor in the mobile phone 260, in a predetermined time set previously in the microprocessor in the mobile phone 260. As a result, it is possible to call the communication party of the user communicated with the user last.

And when switching the hands-free phone and sound linker selecting switch 259 is switched to the position 2, the external sound apparatus is not generally assumed as a mobile phone but assumed to use MP3 and DVD as external audio apparatuses. That is, since a mobile phone has sound signal input terminal and sound signal output terminal whereas an external audio apparatus has the sound signal output terminal divided into left and right terminal, it is to use one end of the mobile phone which is used as a sound signal input terminal as left one of the sound signal output terminal of the external audio apparatus. If let us assume that the external audio apparatus is a MP3, the sound signal output from the right sound signal output terminal is mixed with the audio signal input from the audio signal generating unit in the left mixing unit 220-1 or/and and right mixing unit 220-2 in accordance with the switching of the multiple selecting switch as the third embodiment of the FIG. 4. And the sound signal output from the left sound signal output terminal of the MP3 is input directly to the left mixing unit 220-1 and is mixed with the audio signal input from the audio signal generating unit.

Therefore, the hands-free phone and sound linker selecting switch 259 allows it to apply the mobile phone and external audio apparatus in multiple uses.

In present embodiment, the stereophonic having multiple switching function can carry out many additional functions not to mention the existing function of hands-free phone apparatus, only by the composition of the sound signal controlling unit which connects the audio apparatus for cars and the mobile phone, that is, without using the circuit components of existing hands-free phone apparatus and sound linker apparatus.

Although the present invention is explained by referring to the preferred embodiments shown above, but various modifications and transformations can be made without departing from the spirit and scope of the invention. Therefore, it is obvious which claims as below include various modifications and transformations belonging to the scope of the invention.

According to the present invention, by mixing the sound signals output from multiple sound apparatuses and letting them to be output at once, a mute phenomenon of relatively weak sounds hardly being heard occurs, which can make only the sound signal of high level to be heard, and can output the sound signal output from multiple sound apparatuses multiply or selectively.

Also, according to the present invention, when the external sound apparatus is a mobile phone, it outputs the weak signals which the mobile phone received after amplifying them again, which allows a normal communication even in a region of a weak signal power. And also, since the disconnection of a call, howling, and echo phenomena decreases which occur often during high speed driving, a driver can concentrate only on driving. As a result, accidents can be prevented.

1. A stereophonic apparatus having multiple switching function, comprising;
an audio signal generating unit for generating an audio signal;
a sound signal controlling unit for outputting a sound signal to a sound signal input terminal of an external sound apparatus and controlling path of a sound signal output from a sound signal output terminal of said external sound apparatus;
a mixing unit for generating a mixed sound signal by mixing an audio signal input from said audio signal generating unit and a sound signal input through said sound signal controlling unit;
an audio amplifying unit for amplifying a mixed sound signal input from said mixing unit; and
an output unit for outputting a mixed sound signal amplified by said audio amplifying unit.

2. The stereophonic apparatus in claim 1, wherein said audio signal generating unit includes at least one of a radio receiving unit which generates an audio signal by receiving a radio signal and a media playing unit which generates an audio signal by playing media.

3. The stereophonic apparatus in claim 1, wherein said sound signal output from said sound signal output terminal of said external sound apparatus is an amplified signal in said external sound apparatus.

4. The stereophonic apparatus in claim 1, wherein said external sound apparatus is a mobile phone.

5. The stereophonic apparatus in claim 4, wherein said sound signal controlling unit comprises:
a microphone unit, having one end connected to said sound signal input terminal of said external sound apparatus and the other end grounded, which converts a voice signal to a sound signal and transmits it to said sound signal input terminal of said external sound apparatus;
a calling mode conversion switch, having one end connected to said sound signal input terminal of said external sound apparatus and the other end grounded, which switches an operating condition of said external sound apparatus to a calling mode or a call waiting mode; and
a secret call switch for switching a sound signal input from said sound signal output terminal of said external sound apparatus to said mixing unit or a secret call output unit.

6. The stereophonic apparatus in claim 5, wherein said calling mode conversion switch is a tact switch.

7. The stereophonic apparatus in claim 5, wherein said microphone unit comprises;
a resistor having one end connected to said sound signal input terminal of said external sound apparatus; and
a microphone having one end connected in series to said resistor and the other end grounded, and converting a voice signal into a sound signal.

8. The stereophonic apparatus in claim 7, wherein said resistor is a variable resistor.

9. The stereophonic apparatus in claim 7, wherein said microphone unit further comprises a diode of which anode is connected in series to said one end of said resistor and cathode is connected in series to said one end of said microphone.

10. The stereophonic apparatus in claim 7, wherein said microphone unit further comprises a diode of which anode is connected to said sound signal input terminal of said external sound apparatus and cathode is connected to said one end of said resistor.

11. The stereophonic apparatus in claim 5, wherein said mixing unit includes a left mixing unit and a right mixing unit.

12. The stereophonic apparatus in claim 11, wherein said sound signal controlling unit further comprises a multiple selecting switch, having one end connected to said secret call switch and the other end connected to said left and right mixing unit, which switches a sound signal output from said sound signal output terminal of said external sound apparatus to at least one of said left and right mixing unit.

13. The stereophonic apparatus in claim 12, wherein said secret call switch and said multiple selecting switch are integrated into one switch, which is used as a secret call switch to output a sound signal output from said sound signal output terminal of said external sound apparatus through said secret call output unit when the switch is switched to a secret call, and is used as a multiple selecting switch to output a sound signal output from said sound signal output terminal of said external sound apparatus into at least one of said left and right mixing unit when the switch is not switched to a secret call.

14. The stereophonic apparatus in claim 11, wherein said sound controlling unit further comprises a hands-free phone and sound linker selecting switch of which one end is connected to said sound signal input terminal of said external sound apparatus and the other end is switched selectively to said microphone unit or one of said left and right mixing unit.

15. The stereophonic apparatus in claim 14, wherein said external sound apparatus is an external audio apparatus, when said hands-free phone and sound linker selecting switch is switched to one of said left or right mixing unit so that said sound signal input terminal of said external sound apparatus is connected to one of said left or right mixing unit.

16. The stereophonic apparatus in claim 5, wherein said calling mode conversion switch is switches an operating condition of said external sound apparatus from a call waiting mode to a recalling mode when a predetermined number of times of calling mode conversion switching signals are input into said external sound apparatus continuously in a predetermined time in a call waiting mode.

17. An apparatus for controlling sound signal, coupled to a stereophonic apparatus and a mobile phone, comprising;
a microphone unit, having one end connected to a sound signal input terminal of said mobile phone and other end grounded, which converts a voice signal into a sound signal and transmits it said sound signal input terminal of said mobile phone;
a calling mode conversion switch, having one end connected to said sound signal input terminal of said mobile phone and other end grounded, which switches an operating condition of said mobile phone to a calling mode or a call waiting mode; and
a secret call switch for switching a sound signal input from said sound signal output terminal of the mobile phone to a mixing unit of said stereophonic apparatus or a secret call output unit.

18. The apparatus for controlling sound signal in claim 17, wherein said calling mode conversion switch is a tact switch.

19. The apparatus for controlling sound signal in claim 17, wherein said microphone unit comprises;
a resistor having one end connected to said sound signal input terminal of said mobile phone; and
a microphone having one end connected in series to said resistor and the other end grounded, and converting a voice signal into a sound signal.

20. The apparatus for controlling sound signal in claim 19, wherein said resistor is a variable resistor.

21. The apparatus for controlling sound signal in claim 19, wherein said microphone unit further comprises a diode of which anode is connected in series to said one end of said resistor and cathode is connected in series to said one end of said microphone.

22. The apparatus for controlling sound signal in claim 19, wherein said microphone unit further comprises a diode of which anode is connected to said sound signal input terminal of said mobile phone and cathode is connected to said one end of said resistor.

23. The apparatus for controlling sound signal in claim 17, wherein said mixing unit of said stereophonic apparatus includes a left mixing unit and a right mixing unit; and
further comprises a multiple selecting switch, having one end connected to said secret call switch and the other end connected to said left and right mixing unit, which switches a sound signal output from said sound signal output terminal of said mobile phone to at least one of said left and right mixing unit.

24. The apparatus for controlling sound signal in claim 23, wherein said secret call switch and said multiple selecting switch are integrated into one switch, which is used as a secret call switch to output a sound signal output from said sound signal output terminal of said mobile phone through said secret call output unit when the switch is switched to secret call, and is used as a multiple selecting switch to output a sound signal output from said sound signal output terminal of said mobile phone into at least one of said left and right mixing unit when the switch is not switched to a secret call.

25. The apparatus for controlling sound signal in claim 23, further comprises a hands-free phone and sound linker selecting switch of which one end connected to said sound signal input terminal of said mobile phone and the other end is switched selectively to said microphone unit or one of said left and right mixing unit.

26. The apparatus for controlling sound signal in claim 25, wherein an external audio apparatus is used as a substitute for said mobile phone, when said hands-free phone and sound linker selecting switch is switched to one of said left or right mixing unit so that said sound signal input terminal of external sound apparatus is connected to one of said left or right mixing unit.

27. The apparatus for controlling sound signal in claim 17, wherein said calling mode conversion switch switches an operating condition of said mobile phone from a call waiting mode to a recalling mode when a predetermined number of times of calling mode conversion switching signals are input into said mobile phone continuously in a predetermined time in a call waiting mode.
